(19) United States
(12) Patent Application Publication
(10) Pub. No.: US 2006/0049725 A1
(43) Pub. Date: Mar. 9, 2006

(54) Modular reconfigurable appliance

(76) Inventor: Lee Simon, Tampa, FL (US)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/534,550

(22) PCT Filed: Jan. 12, 2004
(86) PCT No.: PCT/US04/00639

§ 371 Date: May 9, 2005

Related U.S. Application Data
(60) Provisional application No. 60/439,347, filed on Jan. 10, 2003.

(51) Int. Cl. F16B 12/00

(52) U.S. Cl. 312/111

(57) ABSTRACT

A modular reconfigurable appliance receptacle having an array of connectors to accommodate to hold a plurality of different appliance units is provided. The modular reconfigurable appliance unit receptacle comprises a frame for holding various appliance units in different spatial configuration, generally horizontal and vertical, and connectors to quickly connect and/or disconnect the appliance units to the type of power utility necessary, such as gas for a stove, and electricity for a microwave oven. The appliance units are removably attached within the frame, and are interchangeable such that they are configurable as desired and can be removed for repair or replacement, with ease. To add to the configurablity of the receptacle, the frame permits one or more appliance units in both vertical and horizontal spaces within and on the frame. The appliance units can be modified to change their appearance with removably attachable decorative covers, such that interchangeability and modification are made quick, easy and affordable.

### FIELD OF THE INVENTION

The present invention concerns a line of kitchen and/or food service-type appliances that can be interchanged within a frame such that as conditions require, different types of appliances can be quickly removed and replaced. More particularly the present invention concerns a frame and a plurality of both generally vertically oriented appliances, such as ovens, and generally horizontally oriented appliances such as stove tops all of which are interchangeable, respective to orientation, within the frame

### BACKGROUND OF THE INVENTION

Current ranges and other appliances do not offer flexibility. That is, when an oven is purchased that oven remains an oven for its entire useful life and cannot be modified to be any other appliance. However, sometimes a conventional oven is purchased and several years later cooking styles require the use of a microwave or convection type oven instead, requiring the purchase of a new oven. Further, if a particular kitchen and/or food preparation and service area is too small to accommodate a new appliance, the original conventional oven must be sold or, if sale is not possible, discarded as a complete loss.

Generally all conventional appliances have a similar limitation, that is that once selected the appliance can only be used for its primary task with little possibility for modification, advancement or change of task. Some of the known specific disadvantages of existing appliances, and specifically kitchen and foodservice area related equipment include:

Standardization of Models. Presently, manufacturers of appliances offer their wares as standardized models. These units are not always designed to meet the needs of the end user. Rather, the end user is often forced to adapt his or her appliance needs to the equipment that is available, perhaps resulting in an undesirable operational or functional compromise.

Limited Modifications. Modifications to the current equipment are labor intensive, if they are even possible. Such modifications include, among others, changing a stove from a four to a five burner system, or replacing burners with a griddle or grill feature, among others. These modifications require service-authorized technicians to perform modifications and the “end work” must usually be done in the field or the entire unit must be shipped back to the factory. Any such modification or remanufacturing generally result in higher costs for the food preparation industry.

Cost of Modifications. The modifications that can currently be made to “standard equipment” generally require re-evaluation by the various approval agencies (such as UL, ETL, NSF and others). Such re-evaluation can significantly increases the cost of customizing equipment, as well as lead time for production, and can reduce the viability of making any such alterations required or desired by the end user.

Maintenance and Repair. The original unit, once set in place, is often difficult to remove and/or access as such units are generally built into cabinets or onto wall units. As a result, most service calls are executed in the field. Service calls in the field are typically expensive and are often inefficient, as all parts are typically not carried by service personnel, or initial diagnosis of a problem can be incorrect requiring more extensive repairs than first thought. Additionally, if a piece of equipment fails, the entire unit must usually be repaired or replaced in its entirety. As is known, by persons having skill in the art, the cost of repairs in the field can be significantly higher than at the factory or at a local, centralized service agency. Further, on-site service is typically one of a manufacturer's largest variables or unknown costs.

Upgrades and Expandability. Similar to modifications, upgrades and expansions of appliances are typically difficult and costly, if possible and available. Once again, an authorized service technician would typically be required to make a service visit at considerable cost and time.

Repetitive Inventory. Because most currently available units are manufactured as a single or unitary piece, additional and costly inventory is often required by manufacturers and distributors in order to keep products available for purchase and for replacement parts. For example, an existing equipment format might require that two six-burner ranges be stocked, one with a standard oven base and one with a convection oven base.

Multiple Formats. Current equipment components utilize a variety of footprints and configurations. This variety increases the production and development costs of a line of products. Because some kitchen and/or food service areas require appliances with a smaller footprint than others, in order for a manufacturer (or a distributor) to accommodate customers necessitating different size appliances, the manufacturer (or distributor) must stock units of all sizes and footprints, consuming storage and display space.

Established Utility Connections. Current equipment supplies and availabilities are based around specific utility formats such as voltage and phase. A change in the voltage or phase of a piece of equipment typically requires the services of an authorized service technician, which as noted above, can be costly.

It is therefore desirable to provide a cooking line, both for commercial and domestic usage, that is designed to keep up with the growing requirements of the evolving food and beverage industry and/or the needs of the modern home.

### BRIEF SUMMARY OF THE INVENTION

We have invented an modular appliance receptacle that eliminates most of the above noted problems while accommodating numerous cooking and kitchen and/or food service preparation appliances and products. Advantageously, the inventive modular appliance receptacle is: user friendly, convenient, economical, easy to manufacture, durable and effective.

It is further desirable to provide a composed, modular, reconfigurable and interchangeable appliance which overcomes most, if not all, of the preceding disadvantages. Other advantages of the present invention will become apparent hereinafter.

In accordance with the present invention, a modular reconfigurable appliance receptacle having one or more appliance units is provided. The appliance receptacle has a frame for holding at least one of the appliance units and comprises a connector for connecting one or more appliance units to utilities as needed. For example, the frame can have connection points, in standard positions, for electricity, gas, water and universal connection ports, such as described hereafter.

The appliance receptacle can be sold with appliance units removably attached within or alone, such that at least one of the plurality of appliance units available can be operatively and removably attached within the frame. Further the attached appliance unit can be, when desired, operatively and removably replaced, such that the appliances are interchangeable, with another of the plurality of appliance units.

In one preferred embodiment, the modular reconfigurable appliance receptacle has a frame having at least one first bay for insertion of at least one generally vertically oriented unit and at least one second bay for placement of at least one generally horizontally oriented unit. In this preferred embodiment, at least one connector and preferably an array series or set of connectors that provide a connector assembly for operably connecting units to utilities as needed are included, such that either a gas, electric, water or steam appliance can be installed in the frame with equal ease. The frame permits one or more of a plurality of interchangeable appliance units to be removably placed, attached or secured into either the first or second bay, as needed. Removable guides can sub-divide the top into 1, 2 or 3 sections. Further, one or more units can be interchanged with another similarly oriented unit when repair or exchange is need or desired.

In one preferred embodiment, the interchangeable plurality of appliance units include generally oven-shaped units and generally stove-top shaped units. For example, the oven shaped units can be traditional gas or electric ovens, convection ovens, warming drawers, or microwave ovens. Moreover, units such as dish washers, wine chillers, ice machines or other refrigeration units can be installed in the oven-shaped space. Further, such units as grills, burners or griddle units, both gas powered and/or electric or sinks, refrigerators and/or steamers, additionally utilizing water or steam connections, can be interchangeably installed in the stove-top shaped units.

It will be understood that the frame of the modular reconfigurable appliance receptacle can be constructed so that it can hold a number of the plurality of appliance units; in a preferred embodiment two appliance units are can be held, one in a generally horizontal configuration and another in a generally vertical configuration. Further, the frame can be constructed so that it can hold more than two appliance units or so that it can accommodate fractional units, such as one-half convection oven and one-half microwave oven in the same frame, or one-half burner stove top and one half griddle stove top. The fractional units being interchangeable among a number of such units.

As an example, which is not intended to be limiting, it will be seen that in one frame unit, an owner (or the manufacturer or distributor) can place a microwave oven and a convection oven, either side by side or one atop the other, in a vertical-oriented opening, and two burners, a griddle and a grill unit in a horizontal-oriented opening. The user can, at some time, remove the microwave oven and the convection oven and replace them with one or more replacement units; for example, both can be replaced with one conventional gas oven. It will be understood that the modular frame can also be used without each potential receptacle location being occupied. Generic covers, sized and configured for the required size and orientation of the vacant slot, would allow the flexibility to add appliances when convenient, and not necessarily at the time of initial purchase. The burners, griddle and grill can be replaced, as desired, with a single unit of six burners, which could be gas or electric, notwithstanding the power source of the original three units. It will be understood that one or more gas units and one or more electrical units can be used simultaneously in each opening, vertically or horizontally oriented, without departing from the novel scope of the present invention. In this way, should it be desired, a gas oven, an electric microwave, a set of gas burners and an electric griddle could all be used in the same frame.

It will be understood, further, that one or more of the appliances, based on the utility requirements of that particular appliance, can attach to and utilize more than one utility type simultaneously. That is to say, a particular appliance, for example, may require both water and electricity and shall have the capacity to connect and utilize both utility formats simultaneously. Further, in a separate embodiment a generally vertical receptacle is provided such that a plurality of a generally vertically shaped appliances can be installed. For example, a microwave oven, a conventional oven and a convection oven can be installed in such a frame, and later interchanged with other similarly shaped appliances, as needed or desired.

A more detailed explanation of the invention is provided in the following description and claims and is illustrated in the accompanying drawings.

### BRIEF DESCRIPTION OF THE DRAWINGS

FIG. 1 is a perspective view of a frame of the present invention in accordance with principles of the present invention.

FIG. 2 is a side elevational view of the frame of FIG. 1.

FIG. 3 is a plan view of a utility chassis, with various utility connections, for use with the device of the present invention.

FIG. 4 is a cross-sectional view of the utility chassis of FIG. 3, taken along the plane of line 4-4 of FIG. 3.

FIG. 5A is a front elevational view of a modular appliance constructed in accordance with the principles of the present invention.

FIG. 5B is a front elevational view of another modular appliance constructed in accordance with the principles of the present invention.

FIG. 5C is a front elevational view of a further modular appliance constructed in accordance with the principles of the present invention.

FIG. 6A is a front elevational view of an upright modular appliance constructed in accordance with the principles of the present invention.

FIG. 6B is a front elevational view of another upright modular appliance constructed in accordance with the principles of the present invention.

FIG. 6C is a front elevational view of another upright modular appliance constructed in accordance with the principles of the present invention.

### DETAILED DESCRIPTION OF THE INVENTION

The following is a description of the best mode and preferred embodiments for practicing the invention. While the present invention is susceptible of embodiments in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent Office, and should not be found to limit the subject matter disclosed herein.

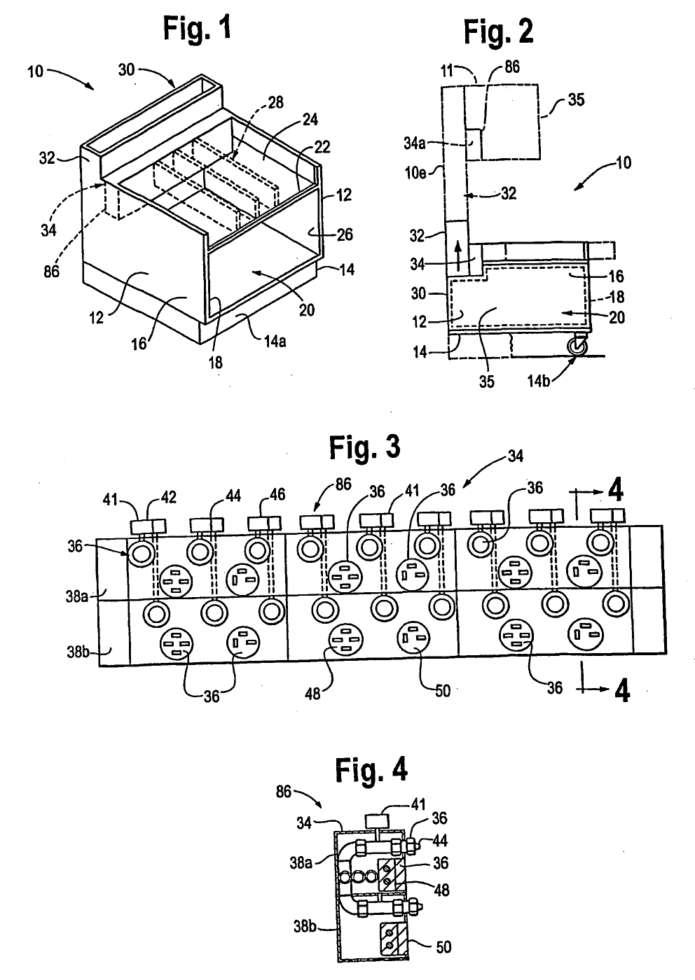

As shown in FIGS. 1 and 2, a modular reconfigurable appliance receptacle includes a frame 10 having sidewalls 12 and a bottom 14. The bottom 14 can be formed as a solid base 14a (FIG. 1), or can include legs or casters 14b (FIG. 2). If casters 14b are used, the whole frame 10 can be wheeled from one location to another.

The frame 10 forms an enclosure 16 with a front opening 18. The interior or cavity 20 of the frame 10, in a first embodiment, can be partitioned by a generally planar or flat horizontal divider 22 into bays such as an upper portion 24 (first bay) and a lower portion 26 (second bay). The upper portion 24 can be further subdivided by upright vertical adapters 28. The back of the enclosure 30 can be formed with a universal flue riser 32. The universal flue riser 32 can be configured so as to provide a smoke and gas discharge as needed.

Further, as shown in FIGS. 1 and 2, enclosure or back 30 can provide and define a utility chassis 34. Utility chassis 34 provides access to power and gas utilities as well as steam and water connections for the various accessories or appliances 35 forming the cooking line, as explained in greater detail below. As shown in more detail in FIGS. 3 and 4, the utility chassis 34 can provide a plurality of sockets 36 of various types. More particularly, at regular intervals along the length of the chassis 34, there can be provided clusters 38 of sockets 36. Preferably, each cluster 38 includes a top portion 38a and a bottom portion 38b. Each cluster portion 38a, 38b could, in the illustrated embodiment, include identical sets 40 of sockets 36. Preferably, each socket 36 is of a quick-connect type socket 36, as is known in the art, ready to accept a matching plug from an accessory, as described in greater detail below.

More specifically, a cluster portion 38a, 38b, in specific embodiments, may include one or more of the following types of sockets 36; gas 42, hot water 44, cold water 46, high voltage (480 vac) 48, and low voltage (120/208 vac) 50 as well as other sockets 36 for new or other utilities as they are developed and incorporated into appliances 35 and houses. It will be understood, by persons having skill in the art that new utilities, such as computer or Internet based and other communication based utilities may be utilized in food preparation and processes and therefore utilities related thereto can be incorporated in the present invention without departing from the novel scope thereof.

The position of each socket 36 within each cluster portion 38a and 38b, can be preferably identical. In this way, each appliance 35 can be made in a standard format to ease the interchangeability of appliances 35 in an appliance 35 line. However, modification, such as changes in position can be accommodated such as with conversion units without departing from the novel spirit and scope of the present invention. Additionally, each cluster 36 can be provided with required safety devices such as shut-off valves or electrical breakers (not shown) and quick disconnect devices for gas, water and electricity and others. Each of such safety and quick release devices can be adapted to close anyone or more of the respective utility and can be of types which are well known in the art. The shut-off valves can be arranged to shut off the utility for each portion independently, or can be arranged to shut off the utility for both portions of a cluster. It will be understood that, additional sockets 36 for other services can be incorporated into the chassis 34, such as vacuum, air, etc. The supply for all of the services is provided to a common location can be located either in the back or the side of the frame.

Referring now to FIG. 3 some examples of well known quick-connect type electrical and plumbing connectors 42 are shown. In the embodiments shown, the top and bottom cluster portions 38a and 38b (FIG. 3) are identical, however, in other embodiments, these cluster portions can be different, as necessary for the particular appliance 35 or type of appliance 35. As previously discussed, the frame 10 has a modular design and can be constructed in either standard size, or several standard sizes, such as in increments of 6, 12 or 3 inches to accept accessories and/or appliances 35 of corresponding widths. Because the cavity 20 (FIG. 1) within the frame 10 is partitioned into an upper 28 and a lower 26 portion, each portion 26, 28 can be used to accommodate a different appliance 35 and/or accessory. Importantly, the upper portions 44a of each utility portions 44 are arranged and constructed to accept and mate with the plugs 46 of a corresponding appliance 35. More specifically, one appliance 35 can be inserted into the bottom portion 20a of the cavity through opening 18 and another appliance 35 can be inserted into the top portion 20b or compartment. Each appliance 35 (FIG. 2) can be constructed, in a convenient place and to correspond with a modular connection system, with its own plug 46 (FIG. 3) so that once the appliance 35 is inserted into the frame 10, it is automatically connected to the sockets 36 within the respective cluster portion.

Accessories and appliances 35 for the cooking line are sized, constructed and arranged to fit into either the upper or lower portion of the frame interior, with connectors formed on their back surface. The accessories and appliances 35 can then be installed by sliding them laterally into the respective interior portion until the quick connectors on their back surface couple or mate with the respect sockets 36 of the utility chassis 34. In this manner, as soon as an accessory or appliance 35 is introduced into the frame, it is automatically connected to the respective utility lines that it requires and it is ready for use.

As shown in FIGS. 1 and 2, a universal flue riser 32 can be provided in the back of the frame. Riser 32 can be connected to a flue riser or other ventilation connection in a manner known to persons having skill in the art. Riser 32 permits any appliance device 35 that requires venting, such as certain types of ovens, having for example broiler means, and cook top grills, to be vented through an exhaust duct and out of the kitchen and/or food service area and building. Additionally, as shown by the broken lines in FIG. 2, the frame 10 can be provided with an extension 10e that can support a secondary appliance holding space 11. Space 11 can be provided with its own utility chassis 34a, as required, and can accommodate additional accessories and appliances 35 that can be installed in the same manner as the accessories and appliances 35 in the main frame interior.

As will be understood by persons having ordinary skill in the art, some accessories and appliances 35 can require additional connections. For example, a sink may require a drain. These additional connections can be provided through the back wall of the frame, either before, or after the accessory or appliance has been installed.

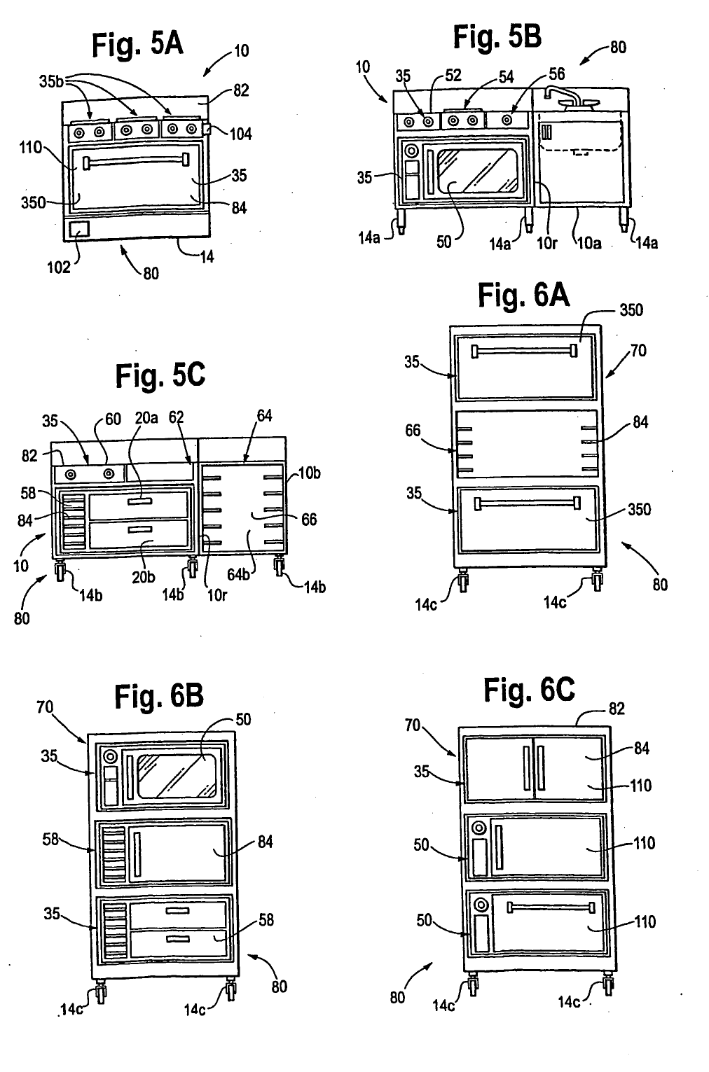

Referring to FIGS. 5A-5C, a number of combinations of appliances 35 are shown, as examples. In FIG. 5A, the frame 10 accommodates a 36-inch oven 35a in its lower portion 26 and three double gas burner 35b units in the upper portion 24. As previously discussed, frames 10 can be provided in various, preferably modular, lengths as needed. However, two or more frames 10 can also be positioned side by side; further, in such units the utility chasses 34 can be interconnected in a manner known by persons having skill in the art.

Referring now to FIG. 5B, it can be seen that one frame 10 can be made to hold a gas or a microwave oven 50 in the lower portion 26, a radial fin 52, a double gas burner 54 and an induction heating unit 56 in the upper portion 24. An auxiliary frame 10a can be attached to the right side 10r of the frame 10 and can be constructed and arranged to include a sink 58 in the upper portion 24. The frames 10, 10a are provided with legs 14a for a base. It will be understood that the configuration shown is only illustrative of the almost innumerable combinations that are contemplated in the present invention.

Referring now to FIG. 5C, it will be see that frame 10 is mounted on wheels or casters 14b. It will be understood by persons having skill in the art that other arrangements of providing a base, legs or casters for the device of the present invention can be used without departing from the novel spirit and scope thereof. In FIG. 5C a refrigerator 58 is placed in the lower portion 26, and a charbroiler 60 and a hot top 62 in the upper portion 24. Further, an auxiliary frame 10b is mounted on the right side 10r of frame 10, to provide a work surface 64 with cantilevered brackets that promote pan sliders 66 to receive trays or pans in the interior compartment or chamber 64b. It will be understood that the configuration shown is only illustrative of one of numerous combinations that are contemplated in the present invention.

In several of the preferred embodiments, as described, a rectangular or box-like frame 10 has been noted. Referring now to FIGS. 6A-68C it can be seen that an upright or vertical frame 70 can be provided to create appliances and appliance combinations utilizing free vertical space in a kitchen and/or food service area. It will be understood that in a preferred embodiment, a vertical utility chassis, not shown but similar in design to the utility chasses shown in FIGS. 5B and 5C.

A universal frame 80 (FIGS. 6A-6C), that is either the originally described frame 10 or the vertical frame 70, can be designed and constructed to accept a number of different cooking surfaces 82 and cavity accessories 84. Frame 80 can feature solid construction using either welding or bolting, or any manner of joining structural elements to form a solidly constructed frame, as known by persons having ordinary skill in the art, featuring the level of quality desired by the consumer or required by code or other governmental, consumer, approval (such as UL, ASTM or others.) or manufacturing group guidelines. It will be understood by persons having skill in the art that all types of structural materials, including, but not limited to steel, iron, aluminum, alloys of metal, wood, plastics, rubber and other materials having desirable characteristics, such as strength, ease of manipulation and construction as well as and flexibility, can be used in the manufacture of the frames and other elements of the receptacles without departing from the novel scope of the present invention.

The required utility infrastructure, provided as part of the frame 80 itself, can be manufactured, in a manner well known in the art, so as to distribute the required utilities throughout the frame 80. Interlocking connectors of the type known in the art can securely and removably fasten the range frames 80 and utility infrastructure components together in desired and desirable configurations.

The frames 80 (FIGS. 6A-6C) can be installed either on casters 14b, for mobility and easy cleaning, or on a structural base 14, for more permanent installations. Where used, the structural base 14 will eliminate the need for a separate concrete curb, as often required by code or manufacturer. Each such frame 80 can be pre-drilled to accept either casters or a base configuration.

Appliance components inserted to comprise the cooking surface of an appliance combination can vary in function and size. The cooking surface of the frame can be designed to accept one (1), two (2) or three (3) components, depending on the size and design of the individual component. For example, the 36″ cooking surface may accept three (3) 12″ modules or two (2) 18″ modules, or one (1) 36″ griddle top.

In an alternate embodiment, to add or remove one of the cooking surface accessories, a release 102, 104 (as explained below) is depressed and the accessory can be released from secure attachment to the surface. For gas units, a gas quick-disconnect valve 41 (FIG. 3) can be depressed, releasing the accessory from the range. In the case of electrical cooking surfaces, the unit will be unplugged, releasing the accessory from the range. Once the accessory is removed, it can be replaced with a different component or standardized flat panel, which will serve as a work surface.

Similar to the cooking surface, the cavity 20 (FIG. 1) of the modular reconfigurable appliance receptacle can include the same type of quick release feature 100 for gas, water, and electric components. A mechanical button 102 (FIG. 5A) on the front face of a range 35 can activate the release. Thus, the cavity components 35 can be removed for repair or replacement with ease.

Both the cooking surface and cavity gas connections can have a gas quick disconnect 104 (FIG. 5A) with such means as a ball valve that prevents gas from leaking from the plumbing fixtures, and other means known to persons having skill in the art. It is well known that a ball valve works by allowing gas to flow when the unit is properly connected and stopping such flow when disconnected. When the unit is removed, gas will not be able to flow, so as to provide safety from gas release in a manner known to persons having ordinary skill in the art.

As previously discussed, a full-height frame 70 (FIGS. 6A-6C) can also be constructed so as to accept two (2) appliance components 35, one in the lower cavity and one in the upper cavity of the full-height frame. This allows the end user additional flexibility to create equipment pieces, through the use of available accessories and components, that will best suit the end users needs.

In a preferred embodiment, the units are provided with interchangeable covers 110 (FIGS. 5A and 6C) such that a user can determine a specific look for the appliance units, such as to provide a specific theme in a kitchen or food service area. In a specific example, should a particular color or material, such as stainless steel or enameled steel, or the like, be desired, particular form fitting covers, of a type similar to those used with modern cellular telephones and/or replaceable front facade panels, can be placed onto the appliance units. As will be understood by persons having skill in the art, such panels can be installed in any of a variety of manners including, snap fittings, by use of fasteners (such as screws), adhesives and hook and eye fasteners (such as that sold under the brand name Velcro®). The ability to change the appearance of appliance units permits the user to modify existing sets of appliances of the present invention, without purchasing new units, such that if the type of appliance(s) previously purchased are still necessary for a particular food service setting and a refreshing of a style or mode is desired, an inexpensive but dramatic change can be made. Further, as restaurants and homes move for more dramatic decors in their respective food service areas, the present invention permits the user to decorate in these areas in ways previously unavailable. It will be understood that access to the utilities already provided through the utility distribution system will allow for both simple and sophisticated decorative adapters ranging in shape, size, color, material, etc. Such sophisticated adapters could include lights, moving parts, and other such integral features that may be desired to integrate with or otherwise enhance the adjacent decor.

Among the many advantages of the inventive, modular, reconfigurable appliance and cooking line of commercial and/or domestic food service equipment are the following:

Flexibility: The end user will have unprecedented flexibility to customize his or her cooking equipment, either during the initial order or in the field. The possible combinations will be endless. This feature will also reduce the cost of upkeep, upgrades, and menu changes by the operator.

Variable Size: The use of frames in the different available sizes will allow the creation of a customizable range in various increments, such as established increments, such as 3 or 6 or 12-inch increments. It will be understood that while units in inches are given, herein, standard units in either imperial or metric denominations could be used without departing from the novel scope of the present invention.

Variable Installation Methods: The same range frame can be installed on casters or a structural base. The end user will specify at the time of ordering which is desired. Both installation methods, however, will be based on the same means of securing the appliance within the frame and the utilities to the appliance.

Plug and Play Capability: Much like a computer system, the frame will accept standardized components for the cooking surface or the cavity, as the end-user needs them. If desired, a customer could order a frame and three (3) two-burner tops, leaving the cavity component as a future purchase. As a result, the equipment meets the needs of the end-user, not the other way around.

End User Buy-in: The end user would be investing in a system, and not just one, freestanding piece of equipment. This could certainly have a positive effect on sales. Incremental sales, or the purchase of additional component, are also more likely and could increase potential revenue.

Longer Life, Lower Cost: Because of the format and flexibility, the life cycle cost associated with this product will be lower than the average range line. If an accessory is no longer operational or desirable, the end-user can replace the accessory, keeping the frame and other accessories in tact. This extends the usable life, and lowers the cost of future replacements.

Maintenance and Repair: The costs of service can be significantly reduced, while simultaneously minimizing customer inconvenience. With modular accessories, the individual component can be removed for servicing. Replacement components can be kept in stock by local service agencies and loaned to the end-user to minimize downtime. The defective or non-working accessory can then be serviced at the local service agent's facility, or sent to a central repair facility operated by the manufacturer. In either event, the number of field service agent hours, and the subsequent costs, can both be reduced.

Cleaning and Maintenance: Removable components make routine cleaning and maintenance easier, because the operator can readily access the parts of the component that require attention. As is understood by users of prior art equipment, maintenance, including servicing and cleaning, on hard-to-access areas in prior art equipment is rarely conducted.

Simplified Manufacturing: The manufacturing process would be simplified. The frames would all be of a standard format, while the accessories would be smaller components that require less time to produce and are easier to handle. Additionally, the “integration” of these components would no longer have to be done in the factory. Rather, assembly of the frame and accessories could be done anywhere (i.e. field, dealer, etc.).

Further, the present invention can also have the following benefits:

Reduction in Cost of Research and Development: Because the format will be universal amongst the cooking surface and cavity components, the cost to develop new components will be reduce. The new items will be designed around a universal format and can utilize the same manufacturing equipment.

Reduced Cavity Component Cost: Because the frame will serve as the structural element, the individual components do not need to replicate this structural integrity for the range. The components can also rely on the structure of the range for support with locking and/or supporting mechanisms. The result is a reduction of materials and cost for these components.

Universal Approvals: Modifications and customization of current products typically require the manufacturer to re-submit the altered product to the required approval agencies (i.e. UL, ETL, NSF, etc.). The manufacturer, by receiving an approval for the commercial cooling line as a single system, and all of its available components, would significantly reduce the cost of this flexibility. No additional approvals should be required to make the numerous available changes possible with this commercial cooking line.

Reduction of Inventory: The inventory required to support field sales would be significantly reduced. The manufacturer would no longer have to stock a six-burner range with a standard oven and a six-burner range with a convection oven. Rather, an order should be filled, such as by pulling a 36″ frame, three (3) 12″ burner sections, and either a convection oven or standard base. Depending on the situation, this modification could be done at the factory, at the dealership, or at the final destination, provided the dealership has all the required parts.

Lower Distribution Costs: Because the accessories will be smaller in size and modular, the units will be easier to ship via readily accessible carriers (i.e. UPS, Federal Express, etc.). A “budget series” six-burner range, for example, can be shipped in with a knocked down frame, three (3) 12″ burner sections and a cabinet or oven base . . . depending on the configuration the end-user has ordered.

Future Compatibility: Because the utilities and standardized component configurations will be provided, the range frame will be able to accept accessories, even perhaps those that have not yet been developed. Forward compatibility is invaluable to the food and beverage industry.

Non-Cooking Accessories: Non-cooking accessories, such as customized shelves, rails, etc., may be developed by the manufacturer and/or third parties. Sharing of the dimensions and configuration of this universal platform would further entrench the brand and product in the marketplace.

Decorative Features: The current emphasis on display kitchen and/or food service areas and for cooking within the view of ones guests, at a restaurant or at home, requires that the cooking equipment's aesthetics be given more attention. The plug and play format can include decorative, customizable covers. The end-user and design team will have the capability to further incorporate the cooking equipment into the interior design of the space. These decorative adapters, similar to modern cell phone cover plates, which permit the customization of cell telephones, can be provided as mechanical (requiring utilities to support a specific feature) or non-mechanical. The modular system and access to utilities provide an opportunity for incorporating both sophisticated and simple decorative adapters.

It will be understood that a number of embodiments have been shown and described, however, no limitation is to be implied by these embodiments. It will be understood by persons having skill in the art that numerous alternative possible methods for construction are available and within the novel scope of the present invention.

It will be understood by persons having ordinary skill in the art, that an important and innovative aspect of reconfigurable appliance receptacle of the present invention is its flexibility in creating a collection of appliances or a cooking appliance that fits the needs of the user. The changes to appliances made possible by the present invention are not only in the physical changes to the way appliances are made and configured but also a philosophical change that will clearly result in numerous different positive outcomes for the end-user, manufacturer, and distributor alike. With the proper manufacturing, marketing, and support, this commercial and domestic cooking line can change the cooking appliance industry.

The changes possible to appliances include, removably-interchangeable cooking surfaces;
removably-interchangeable cavity components; removably-interchangeable decorative finishes;
provision of frames with pre-piped, pre-wired, and pre-plumbed utility infrastructure pre-prepared to accept available components; as well as various range or stove-top format that are expandable in the field.

Although illustrative embodiments of the invention have been shown and described, it is to be understood that various modifications and substitution, as well as other appliances, equipment, devices, and connectors, can be made by those skilled in the art without departing from the novel spirit and scope of the invention.

What is claimed is:

1. A modular reconfigurable appliance receptacle comprising:
a plurality of appliance units;
a frame for holding at least one of the plurality of appliance units;
at least one connector for connecting the appliance units to utilities as needed;
wherein at least one of the plurality of appliance units is operatively and removably attached within the frame; and
the attached appliance unit can be operatively and removably replaced with another of the plurality of appliance units.

2. The modular reconfigurable appliance receptacle of claim 1, wherein the frame is divided into areas, such that a plurality of appliance units can be removably held, in each area, in the divided frame.

3. The modular reconfigurable appliance receptacle of claim 1, wherein the frame can be connected and/or interconnected to another frame adjacent thereto.

4. The modular reconfigurable appliance receptacle of claim 3, including a utility chassis for connecting appliances to utilities within the frame, the utility chassis being positioned such that appliances placed in the adjacent frame can be connected to utilities either within the frame, or within the adjacent frame.

5. The modular reconfigurable appliance receptacle of claim 1, wherein the frame can hold two of the plurality of appliance units, one in a generally horizontal configuration and another in a generally vertical configuration.

6. The modular reconfigurable appliance receptacle of claim 1, wherein the frame can hold two or more of the plurality of appliance units, at least one appliance unit in a generally horizontal configuration and at least one appliance unit in a generally vertical configuration.

7. The modular reconfigurable appliance receptacle of claim 1, wherein the plurality of appliance units includes generally oven-shaped appliance units and generally stove-top shaped appliance units.

8. The modular reconfigurable appliance receptacle of claim 5, wherein a stove-top shaped appliance unit is placed in a generally horizontal configuration on the frame and an oven-shaped appliance unit is placed in vertical configuration on the frame.

9. The modular reconfigurable appliance receptacle of claim 6, wherein the generally oven-shaped appliance units are selected from the group consisting of: gas ovens, electrical ovens, convection ovens, microwave ovens, refrigeration units, dish washing units and warning drawer units.

10. The modular reconfigurable appliance receptacle of claim 8, wherein the generally stove top-shaped appliance units are selected from the group consisting of: burner units, griddle units, refrigeration, ventilation units, and warming units.

11. The modular reconfigurable appliance receptacle of claim 1, wherein the appliance units comprise commercial grade appliance units.

12. The modular reconfigurable appliance receptacle of claim 1, wherein the appliance units comprise domestic grade appliance units.

13. A modular reconfigurable appliance receptacle, comprising:
a frame having at least one first bay for insertion of at least one substantially vertically oriented appliance unit and at least one second bay for placement of at least one substantially horizontally oriented appliance unit;
at least one connector for operably connecting units to utilities as needed;
wherein one or more of a plurality of interchangeable appliance units can be removably placed and secured into either the first or second bay; and
the appliance units can be interchanged with another similarly oriented appliance unit.

14. The modular reconfigurable appliance receptacle of claim 13, wherein the frame can hold two of the plurality of appliance units, one in a generally horizontal configuration and another in a generally vertical configuration.

15. The modular reconfigurable appliance receptacle of claim 13, wherein the plurality of appliance units includes generally oven-shaped appliance units and generally stove-top shaped appliance units.

16. The modular reconfigurable appliance receptacle of claim 14, wherein a stove-top shaped appliance unit is placed in a generally horizontal configuration on the frame and an oven-shaped appliance unit is placed in a generally vertical configuration on the frame.

17. The modular reconfigurable appliance receptacle of claim 15, wherein the generally oven-shaped appliance units are selected from the group consisting of: gas ovens, electrical ovens, convection ovens, microwave ovens, small refrigeration units, dish washing units, and warming drawer units.

18. The modular reconfigurable appliance receptacle of claim 15, wherein the generally stove top-shaped appliance units are selected from the group consisting of: burner units, griddle units, ventilation units, and warming units.

19. The modular reconfigurable appliance receptacle of claim 13, wherein the appliance units comprise commercial grade appliance units.

20. The modular reconfigurable appliance receptacle of claim 13, wherein the appliance units comprise domestic grade appliance units.

21. The modular reconfigurable appliance receptacle of claim 13, wherein the frame is substantially vertically oriented.

22. The modular reconfigurable appliance receptacle of claim 21, wherein two appliance units are removably attached to the frame.

23. The modular reconfigurable appliance receptacle of claim 21, wherein three appliance units are removably attached to the frame.

24. The modular reconfigurable appliance receptacle of claim 13, including decorative covers and wherein the frame and appliance units include means to removably attach the decorative covers thereto.
